(19) United States
(12) Patent Application Publication
(10) Pub. No.: US 2017/0253946 A1
(43) Pub. Date: Sep. 7, 2017

(54) METHOD FOR PROCESSING AND REMOVING ELECTRONIC WASTE WITH A VIEW TO RECOVERING THE COMPONENTS INCLUDED IN SUCH WASTE

(71) Applicant: BIGARREN BIZI, Bidart (FR)

(72) Inventors: Stéphane PEYS, Bordeaux (FR); Ashley O'SULLIVAN, Villefranche de Rouergue (FR)

(21) Appl. No.: 15/511,073

(22) PCT Filed: Sep. 15, 2015
(86) PCT No.: PCT/IB2015/057075

§ 371 Date: Mar. 14, 2017

(30) Foreign Application Priority Data
Sep. 15, 2014 (FR) 14/58646

(51) Int. Cl. C22B 7/00; B03B 5/48; B03B 9/06; B03C 1/02; C22B 1/24; B03B 5/28

(52) U.S. Cl. CPC C22B 7/005; C22B 1/2406; B03B 5/28; B03B 9/06; B03C 1/02; B03B 5/48

(57) ABSTRACT

According to the invention, a method for treating electronic waste with a view to individually recovering metals included in such waste is provided. Said method is characterized in that it includes the series of the following steps: grinding the waste under conditions suitable for individually separating the different metal components of the waste; mixing the ground waste with a liquid such as to form a suspension; gravitationally separating the suspension such as to separate the particles having the highest densities and containing the majority of the metals from the particles having the lowest densities; and densimetrically separating the suspension containing the majority of the metals such as to obtain suspensions containing the individually separated metals.

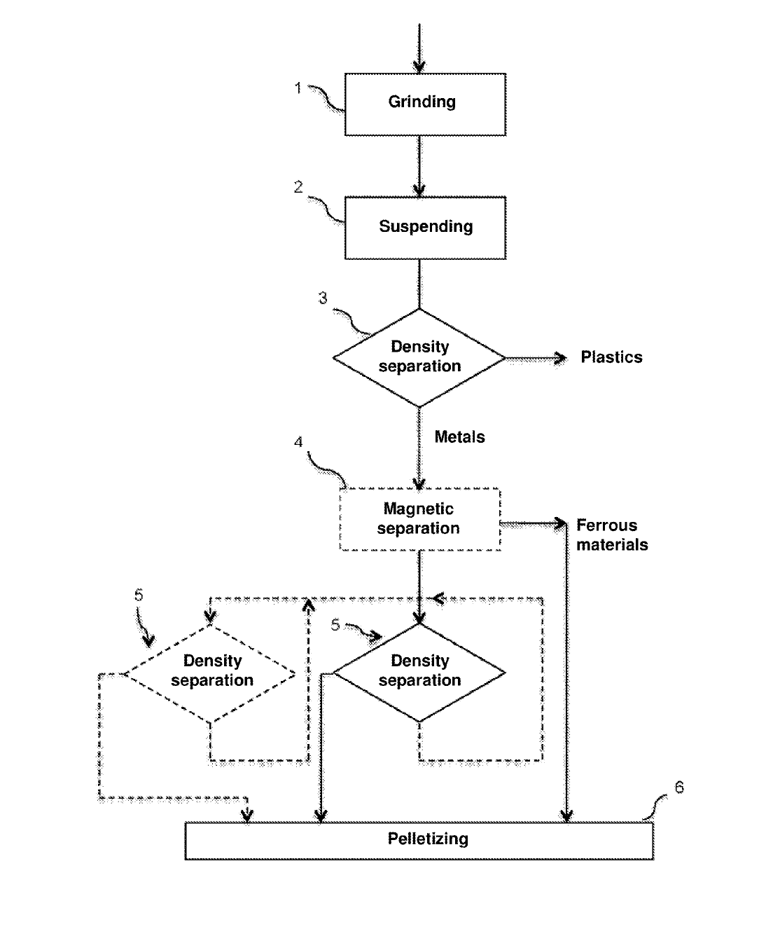

### FIELD OF THE INVENTION

The present invention relates to the treatment of articles comprising plastic materials and various metals, and in particular electronic waste, with a view to recovering materials forming the latter, and in particular the metals used in the production of such waste.

This waste may comprise circuit boards, memory cards, smart cards, and any other circuit or article provided with discrete or integrated electronic components.

### PRIOR ART

This electronic waste essentially comprises two families of materials, namely on the one hand polymer materials, and on the other hand metals, some precious and others less so, and in particular (but not exhaustively) silver, copper, iron, lead, tin, gold, silver, aluminum, tantalum, palladium, and rare-earth metals (lanthanides).

The recovery of these metals is today an extremely important challenge with regard to environmental motivations that aim to recover and recycle unusable or deteriorated waste, and the increasing rarity of certain metals.

There is therefore not only an economic benefit, but also an environmental benefit in treating this waste in order to recover therefrom the materials capable of being reused, and in particular the metals.

However, this treatment comes up against significant difficulties:
the amount of each of the metals to be recovered is relatively small with regard to the total weight or the total volume of this waste;
this same waste includes different metals which are a priori difficult to separate considering their similar properties, in particular in terms of densities for certain metals;
the presence of polymer materials in the waste further complicates the treatments.

Thus, the known techniques for recovering metals in waste comprising only a single type of metal, in particular by refining or melting, cannot be used directly for such applications.

Therefore, processes that aim to recover various metals contained in electronic waste have already been developed.

In a first known process, based on pyrometallurgy, the waste is sequentially subjected to:
a heat treatment in order to homogenize the source of metal (roasting) and to separate the plastics and the refractory oxides;
an oxidation that enables the separation; and
a refining.

Such a process is particularly used for recovering copper, nickel or zinc.

However, this known process has drawbacks, and in particular:
the fact of burning the plastic materials and other inflammable materials has harmful consequences in terms of the environment, in particular by the emission of furans and dioxins;
it calls for a chemical treatment, the environmental consequences of which are significant;
it is energy intensive and requires long treatment times;
it is limited to the recovery of certain metals, excluding in particular aluminum, iron and tantalum.

A process referred to as a hydrometallurgical process has also already been proposed, which is based on the use of a solvent, and in particular of an acid or a halide, followed by separation and purification processes for instance by precipitation of the impurities, extraction of the solvent, adsorption and ion exchange in order to isolate and concentrate the metals.

For example, oxidation of electronic waste by sulfuric acid enables the leaching of the copper and of the silver, whereas cyanidation makes it possible to recover gold, silver, palladium and a small amount of copper.

The hydrometallurgical process is resorted to in particular for aluminum, zinc and copper, but also for nickel, chromium and manganese.

However, this known process uses large amounts of acid, which is a great handicap in terms of the environment and safety.

Biotechnological processes that require bacteria or fungi have also been proposed, in a known manner.

However, these processes are still in the experimental phase and have not yet proven their effectiveness, in particular with regard to economic and environmental criteria.

Finally, a technique is known from the document “A Novel Flowsheet for the Recovery of Metal Values from Waste Printed Circuit Boards” that makes it possible, via a combination of wet-phase treatments (sizing by hydrocycloning, flotation and multi-gravity separation) and dry-phase treatments (electrodynamic and electrostatic separations), to separate the constituents of ground printed circuit boards into, on the one hand, a light fraction (essentially plastic materials) and, on the other hand, a heavy fraction (essentially metals).

However, this known process results in a mediocre separation performance, and proves to be incapable of separating the metals from one another.

Furthermore, the teaching of this document indicates (see table 1 on page 465) that an effective separation occurs only for particle sizes between 44 and 100 μm and that smaller particles should be removed. Moreover, this document appears to indicate that the grinding of circuit boards produces large amounts of nonmetallic fines and of metal particles of elongated shape, which would a priori complicate a completely mechanized separation process.

Thus, for want of satisfactory industrial solutions, there are still many regions of the world where electronic waste is simply burnt, in order to attempt to recover a small portion of the metals. These processes are however a disaster in terms of the environment and health, and ultimately only enable a minimal recovery of materials.

### SUMMARY OF THE INVENTION

The present invention aims to overcome all or some of the drawbacks of the prior art and to propose a process that makes it possible to individually recover various metals included in the composition of electronic waste, with a satisfactory degree of purity, while requiring neither heat input nor reactants, and that does not produce undesirable emissions. It is based on the discovery of the fact that, by carrying out a fragmentation of this waste with certain particle size characteristics, making it possible to individually separate the constituents of the waste, and by conveying these fragments in a liquid medium from one end to the other of the separation process, it was possible to apply thereto extremely effective mechanical separation treatments, without recourse to reactants, without undesirable emissions and with a limited energy consumption.

A process is thus proposed for treating electronic waste with a view to individually recovering metals included in such waste, characterized in that it comprises the series of the following steps:
grinding the waste under conditions suitable for individually separating the various metal constituents of the waste,
mixing the ground waste with a liquid to form a suspension,
separating, by gravity, the suspension in order to separate the particles of highest densities, containing most of the metals, from the particles of lowest densities,
separating, by density, the suspension containing most of the metals in order to obtain suspensions containing the individually separated metals.

Certain advantageous but optional features of this process, taken individually or in any combination that a person skilled in the art will identify as technically compatible, are the following:
the mean size of the metal particles after the grinding step is between around 10 and 100 μm, and more preferentially between 20 and 50 μm;
the metal particles have, after grinding, a distribution value D80 between around 25 and 60 μm;
at least one final phase of the grinding is carried out by attrition;
the gravity separation step is carried out by hydrocycloning;
the proportion of solids in the suspension is between around 5% and 30% by weight, preferably between around 8% and 15% by weight;
the liquid is water, the suspension additionally containing a wetting agent;
the wetting agent is nonionic;
the density separation step is carried out by one or more separation a machines selected from a group comprising centrifugal gravity separators, densimetric tables, flotation-type separators, spiral concentrators and multi-gravity drum separators;
the process comprises a set of separation machines connected in cascade and set to different density ranges;
the process comprises, before the density separation step, a magnetic separation step;
the process additionally comprises a final packaging step comprising an elimination of the liquid and a pelletizing of the separated metals.

### BRIEF DESCRIPTION OF THE DRAWINGS

The invention will be better understood in light of the following description of preferred embodiments thereof, given by way of nonlimiting example and with reference to the appended drawings, in which the sole FIGURE is a block diagram of the various steps of the process of the invention.

### DETAILED DESCRIPTION OF PREFERRED EMBODIMENTS

With reference to the drawing, the various steps of the process of the invention and means for carrying out these steps will be described below.

The process comprises the following steps.

Step 1: Micronization

This step comprises a grinding of the electronic waste (whole boards, smart card, etc.) until a powder of particles having a mean size preferably between 10 and 100 μm, and more preferentially between around 20 and 50 μm is obtained. This grinding may be carried out in one or more steps depending on the nature of the waste and the expected composition thereof, optionally with regrinding of the excessively coarse particles originating from a downstream particle size screening operation.

The targeted particle size here is that of the metals, it being possible for the grinding to give rise to coarser sizes of non-metallic particles (in particular plastics, which are more malleable) without compromising the effectiveness of the process.

Advantageously, the grinding is carried out under conditions such that the mean size of the metal particles after the grinding step is as defined above and such that the distribution of the size of the metal particles has a distribution value D80 between around 25 and 60 μm. It will be recalled here that a distribution value D80 is the size of particles for which 80% of the particles have a size lower than this value.

It should be pointed out here that grinding with such a particle size makes it possible to ensure that the various constituents of the electronic products treated are individually separated well enough to be able to guarantee the good quality of the subsequent separation steps, as will be described.

Various suppliers sell machines based on various grinding technologies (ball mills, attrition mills, knife mills, centrifugal mills, etc.) and which are capable of carrying out this grinding, and in particular the company Poittemill, Béthune, France, the company Manfredini & Schianti, Sasuollo, Italy, the company Atritor, Coventry, United Kingdom, the company Pulveris, Aniche, France, or else the company Hosokawa Alpine, Augsburg, Germany.

Furthermore, it is advantageous for the type of grinding to be chosen so as to give a mean size of metal particles smaller than the mean size of non-metallic particles. This makes it possible, on the one hand, to make the metals/nonmetals separation less time-consuming and, on the other hand, to improve the performance of the separation of the metals from one another.

Attrition grinding makes it possible in particular to lead to this result.

Step 2: Aqueous Suspending

The particles micronized in step 1 are introduced into an aqueous medium, preferably water, in a proportion of around 8% to 15% by weight of solids; this suspending may be carried out by stirring in a tank; if necessary, a wetting agent such as a surfactant, which is preferably nonionic and nonfoaming, is incorporated into the aqueous medium to facilitate the suspending.

This liquid medium remains the carrier for the micronized particles throughout all the subsequent steps, and will be eliminated at the end of the separation as will be seen below.

Step 3: Metals/Nonmetals Separation

This step is preferably carried out with a hydrocyclone-type separation device, making it possible to separate, on the one hand, the particles of highest densities (typically all of the metals) and, on the other hand, the particles of lowest densities, typically the polymers and other nonmetallic particles. In a manner known per se, the densest particles are projected against the conical wall of the hydrocyclone and are discharged from the hydrocyclone through its lower opening (underflow), whilst the lighter particles rise up through the upward secondary vortex and form a flow referred to as an overflow that emerges through an upper opening.

By an optimal choice of the diameter of the cyclone, of its length and of the cone angle of the cyclone, of the outlet diameter of the overflow in the vortex finder, of the diameter of the spigot of the underflow, the heaviest particles (metals) are successfully directed toward the lower opening, whereas the lighter materials (polymers) in suspension in the solution rise up in the upward vortex and exit through the upper opening, with a possibility of fine adjustment of the density threshold.

Use is made, for example, of a hydrocyclone manufactured by the company Salter Cyclones Ltd., Cheltenham, United Kingdom, the company FLSmidth & Krebbs, Valby, Denmark, the company Neyrtec Mineral, Lorient, France, or else the company Multotec, Johannesburg, South Africa.

Step 4: Magnetic Separation (Optional)

The densest particles resulting from the hydrocycloning, essentially consisting of metal particles in suspension in the liquid stream, are subjected to a magnetic separation in order to isolate the magnetic metals, typically the ferrous metals, from the other metals.

It is possible, for example, to carry out the process proposed commercially by the company Liquisort Recycling B.V., El Son, the Netherlands.

It will be noted here that depending on the type of electronic waste, this step is optional. In particular, ferrite-type materials may also, where appropriate, be recovered by the downstream density separation step that will now be described.

Step 5: Density Separation

The particles essentially consisting of metals of various densities (either the nonferrous metals resulting from the magnetic separation, or all of the metals resulting from the preceding step when no magnetic separation is provided) are then subjected to a density separation step that aims to isolate the metals of various densities from one another. The separation means may be selected from centrifugal gravity separators, densimetric tables, and flotation-type separators or spiral concentrators. Depending on the nature of the waste, the number of metals to be separated and the type of separator, the separation means may be arranged in various ways. Advantageously, gravity concentrators such as those of the Falcon range sold by the company Sepro, Langley, Canada or else those (Knelson concentrators) sold by the company FLSmidth & Krebbs, Valby, Denmark, or else preferentially multi-gravity drum separators sold by the company Salter Cyclones Ltd., Cheltenham, United Kingdom are used.

Preferentially, the stream of the liquid medium transporting the particles to be separated is cascaded through a series of separation devices, each device delivering a metal having a certain density. Still depending on the type of separator, it is possible to proceed according to increasing densities or according to decreasing densities (decreasing densities with the Salter multi-gravity separators).

Optionally, each separation is repeated in order to increase the concentration and thus achieve the desired degree of purity for each metal.

Moreover, depending on the separation capacity of the machines with respect to the liquid stream to be treated, it is possible to provide, for the separation of a given metal, several machines operating in parallel or cascade.

Typically, provision is made for the adjustment of the machines for the separation of the following metals: aluminum, copper, iron, lead, tin, gold, silver, tantalum. But, depending on the upstream nature of the treated waste (in particular the qualities of the circuit boards), it is possible to decide to disregard some metals, or to add others.

In the case of metals of similar densities, it is additionally possible to separate them together, and provide a subsequent differentiating treatment.

It will furthermore be noted that, upstream, a hydrocycloning separation of the same type as that used for separating the plastic materials may be carried out to separate the least dense metals, and in particular aluminum.

Step 6: Final Packaging

The various metals separated in the preceding step, still in the form of particles in a liquid carrier, are stripped of the liquid, typically by filtration and drying, then subjected to packaging treatments, such as pelletizing via compacting, for each of the metals recovered.

Where appropriate, it is possible to carry out an upstream characterization of the waste to be treated, by any known method of analysis, in order to optionally adjust the steps of the process, and in particular the parameters of the hydrocycloning and of the density separation.

It is also possible to carry out a final characterization of the metals recovered, in order to estimate their degree of purity and to identify possible secondary metals still present, and to detect possible separation problems in the process.

Naturally, the present invention is in no way limited to the preceding description, but a person skilled in the art will know how to introduce numerous variants or modifications thereto.

1. A process for treating electronic waste with a view to individually recovering metals included in such waste, wherein it comprises the series of the following steps:
grinding the waste under conditions suitable for individually separating the various metal constituents of the waste,
mixing the ground waste with a liquid to form a suspension,
separating, by gravity, the suspension in order to separate the particles of highest densities, containing most of the metals, from the particles of lowest densities, and
separating, by density, the suspension containing most of the metals in order to obtain suspensions containing the individually separated metals.

2. The process as claimed in claim 1, wherein the mean size of the metal particles after the grinding step is between around 10 and 100 μm, and more preferentially between 20 and 50 μm.

3. The process as claimed in claim 1, wherein the metal particles have, after grinding, a distribution value D80 between around 25 and 60 μm.

4. The process as claimed in claim 1, wherein at least one final phase of the grinding is carried out by attrition.

5. The process as claimed in claim 1, wherein the gravity separation step is carried out by hydrocycloning.

6. The process as claimed in claim 1, wherein the proportion of solids in the suspension is between around 5% and 30% by weight, preferably between around 8% and 15% by weight.

7. The process as claimed in claim 1, wherein the liquid is water, the suspension additionally containing a wetting agent.

8. The process as claimed in claim 7, wherein the wetting agent is nonionic.

9. The process as claimed in claim 1, wherein the density separation step is carried out by one or more separation machines selected from a group comprising centrifugal gravity separators, densimetric tables, flotation-type separators, spiral concentrators and multi-gravity drum separators.

10. The process as claimed in claim 9, wherein it comprises a set of separation machines connected in cascade and set to different density ranges.

11. The process as claimed in claim 1, wherein it comprises, before the density separation step, a magnetic separation step.

12. The process as claimed in claim 1, wherein it additionally comprises a final packaging step comprising an elimination of the liquid and a pelletizing of the separated metals.
